(19) United States
(12) Patent Application Publication
(10) Pub. No.: US 2010/0198408 A1
(43) Pub. Date: Aug. 5, 2010

(54) In-line loss-on-ignition measurement system and method

(76) Inventors: Daniel Harjes, Allston, MA (US); John Williams, Lexington, MA (US); James A. Bickford, Winchester, MA (US); Daniel Traviglia, Allston, MA (US); David G. D'Amore, Winthrop, MA (US); James D. Derouin, Taunton, MA (US)

Correspondence Address: Iandiorio Teska & Coleman, 260 Bear Hill Road, Waltham, MA, 02451, US

(21) Appl. No.: 12/657,706

(22) Filed: Jan. 26, 2010

Related U.S. Application Data
(60) Provisional application No. 61/205,961, filed on Jan. 26, 2009.

(51) Int. Cl. F23N 5/26; G06F 19/00

(52) U.S. Cl. 700/274; 702/24

(57) ABSTRACT

An in-line loss-on-ignition measurement system featuring an extractor configured to collect fuel or a combustion by-product from a hydrocarbon fuel burning plant, an on-site analyzer configured to receive the collected matter and determine loss-on-ignition data for the plant, a transfer mechanism configured to transfer the collected matter from the extractor to the analyzer, and a controller for displaying the loss-on-ignition data and/or for automatically adjusting one or more parameters associated with the plant.

### RELATED APPLICATIONS

This application hereby claims the benefit of and priority to U.S. Provisional Application Ser. No. 61/205,961, filed on Jan. 26, 2009 under 35 U.S.C. §§119, 120, 363, 365, and 37 C.F.R. §1.55 and §1.78.

### FIELD OF THE INVENTION

The subject invention relates to hydrocarbon (e.g., coal) burning plants and a system and method for measuring loss-on-ignition of such plants.

### BACKGROUND OF THE INVENTION

In industrial generators, hydrocarbon fuel, such as coal is burned to create steam used to drive turbine generators. For a combustor to operate efficiently and to produce an acceptably complete combustion that generates bi-products falling within the limits imposed by environmental regulations and design constraints, all of the individual burners in the combustor must operate cleanly and efficiently and all post-combustion systems must be properly balanced and adjusted. Emissions of unburned carbon (i.e., loss-on-ignition (LOI) data), NOx, carbon monoxide and/or other bi-products are generally monitored to ensure compliance with environmental regulations and to ensure compliance with design constraints. See U.S. Pat. No. 6,389,330 incorporated herein by this reference.

As stated in the '330 patent, some emissions, such as the concentration of unburned carbon in fly-ash, are difficult to monitor on-line and continuously. In most cases, these emissions are measured on a periodic or occasional basis by extracting a sample of ash and sending a sample to a laboratory for analysis. Usually the sample of fly-ash is sent to an offsite lab where the sample is weighed, burned, and reweighed. The analysis may take days to a week or more. Most power plants do not have a chemical lab on-site and, due to the elapsed time for an analysis, the plant efficiency is frequently not at an optimum level. The '330 patent proposes monitoring the radiation emitted from a post-flame zone of the combustor and in response to a fluctuational component of the radiation and then calculating one or more combustion parameters.

The RCA 2000 residual carbon analyzer (M&W Asketeknik) is advertised to extract fly-ash from the flue gas via a cyclone and analyze it in a transducer using light. The result of the analysis is sent to the control room.

Still, it appears no prior system is able to measure loss-on-ignition (LOI) directly, on-site, continuously, automatically (e.g., without the need for operator intervention) and without the need for calibration.

### BRIEF SUMMARY OF THE INVENTION

It is therefore an object of this invention to provide a new loss-on-ignition measurement system and method. Such a system and method, in one preferred embodiment, is able to measure loss-on-ignition directly and is able to measure loss-on-ignition on-site in a continuous and automatic fashion without the need for extensive calibration. It is a further object of this invention to provide such a system and method which, in one example, is self-cleaning.

The subject invention, however, in other embodiments, need not achieve all these objectives and the claims hereof should not be limited to structures or methods capable of achieving these objectives.

This invention features an in-line loss-on-ignition measurement system typically including an extractor configured to collect fuel or a combustion by-product from a hydrocarbon fuel burning plant and an on-site analyzer configured to receive the collected matter and determine loss-on-ignition data for the plant. A transfer mechanism which may include one or more valves is configured to transfer the collected matter from the extractor to the analyzer. A controller displays the loss-on-ignition data and/or automatically adjusts one or more parameters associated with the plant. The system is typically used in a coal burning plant where the by-product is fly-ash.

In one example, the analyzer is a thermal gravimetric analyzer configured to weight the fly-ash, burn the fly-ash, and weigh the fly-ash again to determine loss-on-ignition. The parameters adjusted may include the air-to-fuel ratio and/or an adjustment to a pulverizer to change the size of the coal particles.

One preferred extractor extends into an exhaust stack. In one example, the extractor includes a body including a catch funnel within the stack and a transverse through hole outside the stack, a moveable piston within the body including a collection volume orifice transversely therethrough in communication with the catch funnel when the piston is extended to receive the fly-ash. The piston collection volume orifice is in communication with the transverse through hole outside the stack when the piston is retracted. A pellet chamber outside the stack is beneath the body through hole. A ram is drivable through both the cylinder through hole and the piston collection volume orifice when the piston is retracted to produce a pellet of the fly-ash in the pellet chamber. In this example, the transfer mechanism typically includes a rotatable valve for transferring the pellet from the pellet chamber to the analyzer. A thermal gravimetric analyzer may include a carousel configured to receive fly-ash pellets from the rotatable valve. Another extractor includes an electro-static precipitator. Still another extractor includes a motor driven rotary auger. A cyclone device may also be used.

The subject invention also features an in-line loss-on-ignition measurement method. Fuel or a combustion by-product from a hydrocarbon fuel burning plant is collected and transferred to an on-site analyzer. The collected matter is analyzed to determine the loss-on-ignition data for the plant, and the loss-on-ignition data is displayed and/or one or more plant parameters are automatically adjusted based on the loss-on-ignition data. In a coal burning plant where the by-product is fly-ash, analyzing typically includes weighing the fly-ash, burning the fly-ash, and weighing the fly-ash again to determine loss-on-ignition data. Collecting may include employing the extractors described above.

In one version, an in-line loss-on-ignition measurement system features a cyclone extractor configured to collect fuel or a combustion by-product from a hydrocarbon fuel burning plant. An on-site analyzer is configured to receive the collected matter and determine loss-on-ignition data for the plant by weighing the collected matter, burning the collected matter, and weighing the burned collected matter. A transfer mechanism includes one or more valves configured to transfer the collected matter from the extractor to the analyzer. A controller displays the loss-on-ignition data and/or for automatically adjusting one or more parameters associated with the plant.

One in-line loss-on-ignition measurement method comprises collecting fuel or a combustion by-product from a hydrocarbon fuel burning plant using a cyclone extractor, transferring the collected matter to an on-site analyzer; analyzing the collected matter to determine the loss-on-ignition data for the plant by weighing the collected matter, burning the collected matter, and weighing the burned collected matter, and displaying the loss-on-ignition data and/or automatically adjusting one or more plant parameters based on the loss-on-ignition data.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a block diagram depicting the primary components associated with a typical coal plant and the steps associated with one prior art method of determining loss-on-ignition;

FIG. 2 is a highly schematic block diagram showing the primary components associated with a more automated system for and method of determining loss-on-ignition in accordance with an example of the invention;

FIG. 3 is a schematic three-dimensional side view showing an example of a fly-ash extractor;

FIG. 4A-4F are schematic cross-sectional views of the fly-ash extractor of FIG. 3 in operation;

FIG. 5 is a schematic cross-sectional view showing a different version of an extractor;

FIG. 6 is a schematic cross-sectional view showing still another example of a fly-ash sample extractor;

FIG. 7 is a schematic three-dimensional partially cross-sectional view showing an example of a thermal gravimetric analyzer useful in accordance with the system and method of the invention;

FIG. 8 is a schematic three-dimensional view showing how the extractor of FIG. 3 interfaces with the carousel input of a commercially available analyzer; and

FIG. 9 is a schematic three-dimensional view of another LOI measurement system in accordance with the invention;

FIG. 10 is a block diagram showing the principle components of a more complete LOT measurement system in accordance with the invention; and

FIG. 11 is a block diagram showing how a LOI measurement system in accordance with the subject invention can be used for combustion process monitoring and control.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

One feature of the subject invention is the ability to measure loss-on-ignition in an automated fashion. Loss-on-ignition is the amount of coal that is not burned in a coal-fired power generation plant. Loss-on-ignition (LOI) typically changes from 2% to 20+%. If the LOI value can be measured in an automated fashion, then the amount of oxygen and coal fed into the furnace and pulverizers can be optimized resulting in higher efficiency, lower fuel cost, and reduced maintenance cost. For example, one energy generating complex burns about two-thousand tons of coal per day. If the yearly LOI were to be reduced from an average of 4% to an average of 3%, over seven-thousand tons of coal would be saved per year in just one plant. Not only would coal be saved, but emissions would be reduced and maintenance costs (per energy output) would be reduced.

The subject invention features an in-line system specifically tailored for rapid LOI sensing in coal and other hydrocarbon burning plants.

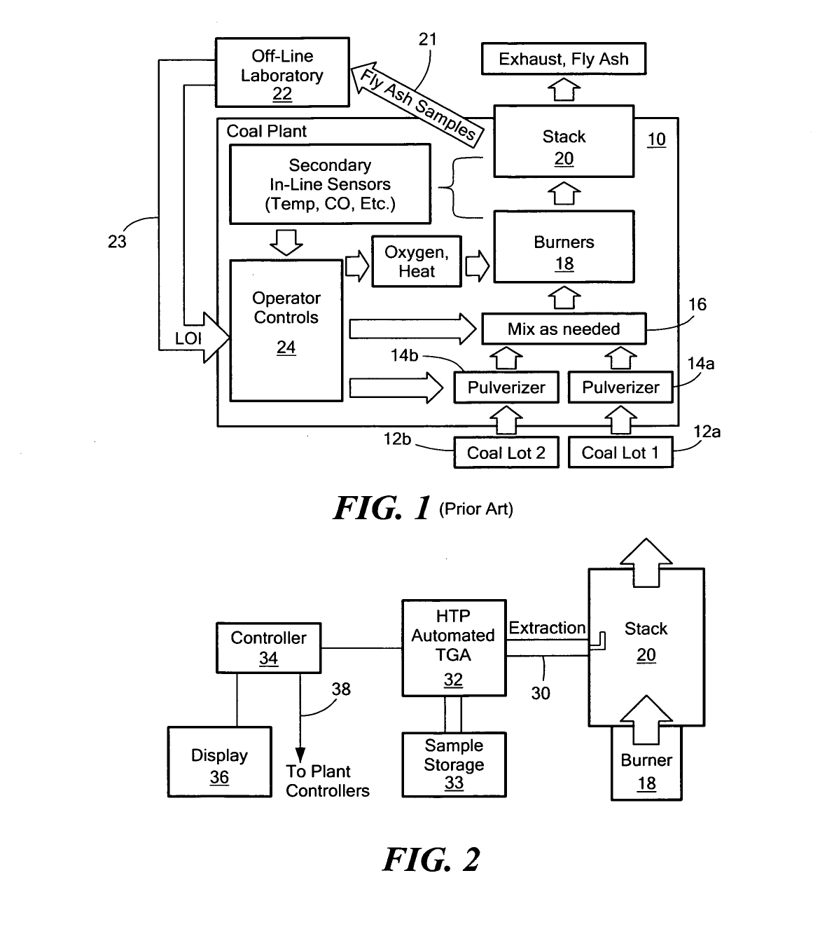

FIG. 1 depicts one prior method of determining loss-on-ignition of coal plant 10. Coal from lots 12a and 12b is pulverized by pulverizers 14a and 14b respectively, mixed (if desired) in mixers 16, and burned by burners 18. Fly-ash samples from stack 20 are collected as shown at 21 and sent to off-line laboratory 22 for analysis. Fly-ash is a combination of all solid matter exiting the coal plant burners. It contains both unburned coal (LOI) and mineral oxides generated from the impurities in each batch of coal. LOI data is then provided to an operator as shown at 23 who may use the various controls 24 to adjust, for example, the air to fuel ratio, and/or or the size of the fuel exiting pulverizers 14a, and 14b. As noted in the Background section above, the analysis process typically takes a few days to a week or more. Because of the elapsed time for analysis, plant efficiency is frequently not at an optimum level.

In accordance with an example of the invention, the LOI data is determined on-site. Extractor 30, FIG. 2, in one example, is configured to collect fuel or, as shown in FIG. 2, a combustion by-product such as fly-ash from coal plant stack 20. In this example, analyzer 32 (e.g., an automatic thermal gravimetric analyzer) receives the fly-ash from the extractor and determines LOI data for the plant. Controller 34 is programmed to display the LOI data on display 36 (located, for example, in the control room of the plant) and/or to control, via electric signals as shown at 38, various plant parameters such as the air to fuel ratio or the size of the fuel exiting the pulverizers. Extracted samples, once analyzed, may be stored as shown at 33.

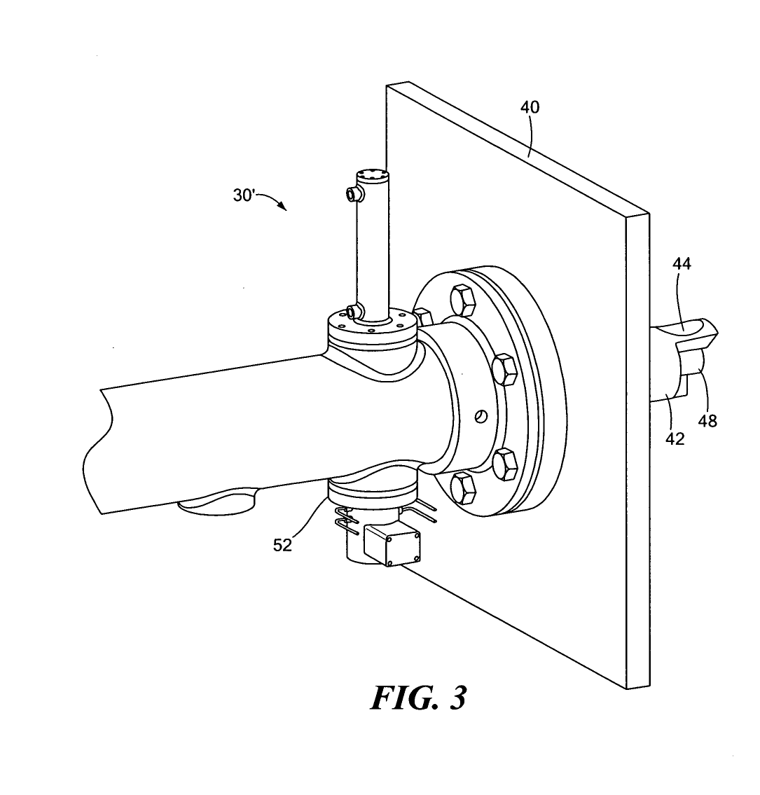

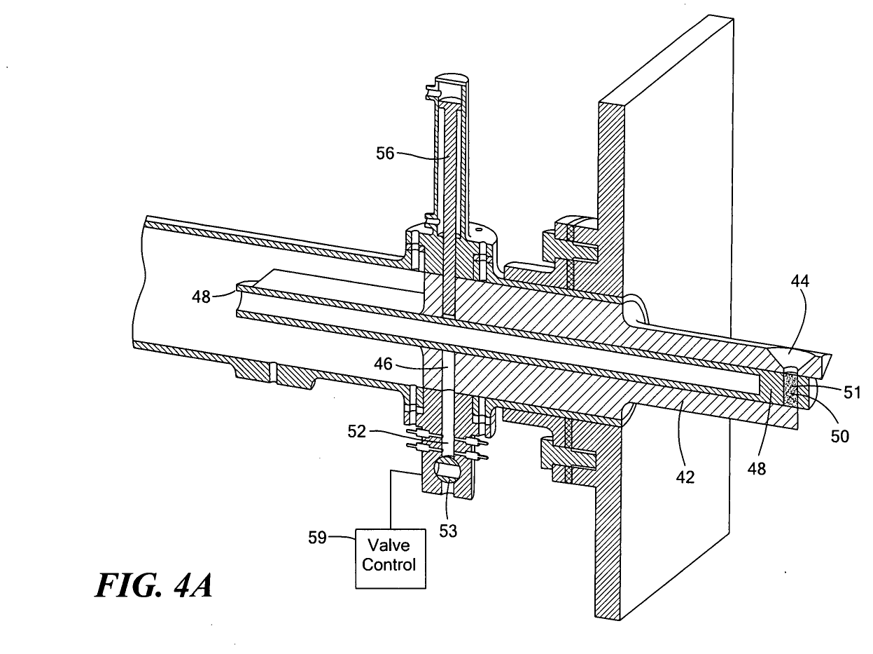

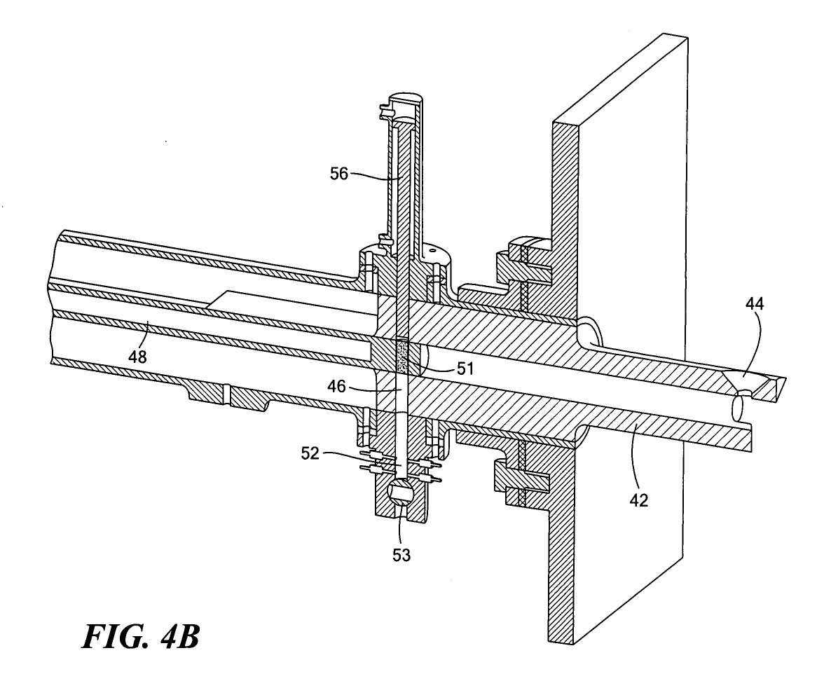

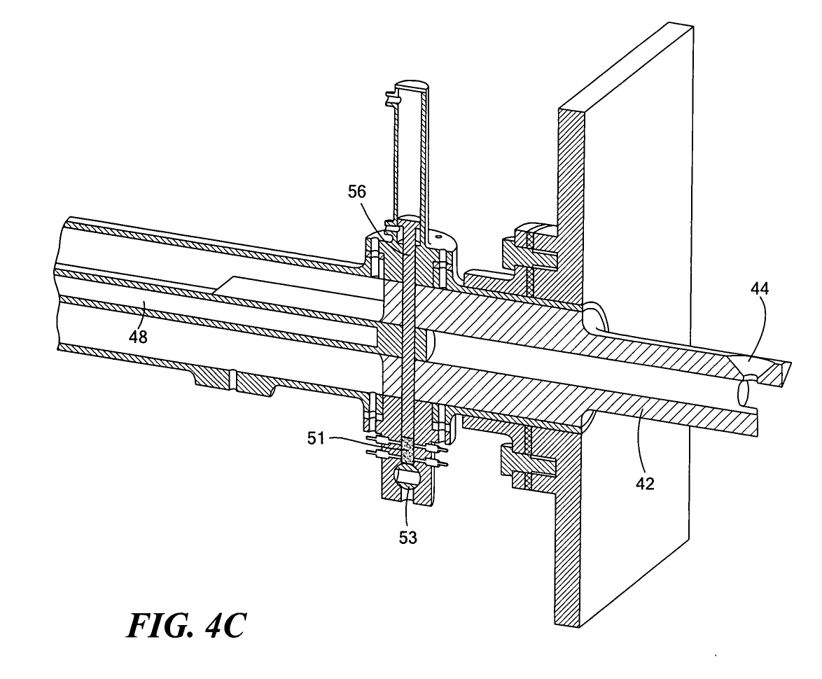

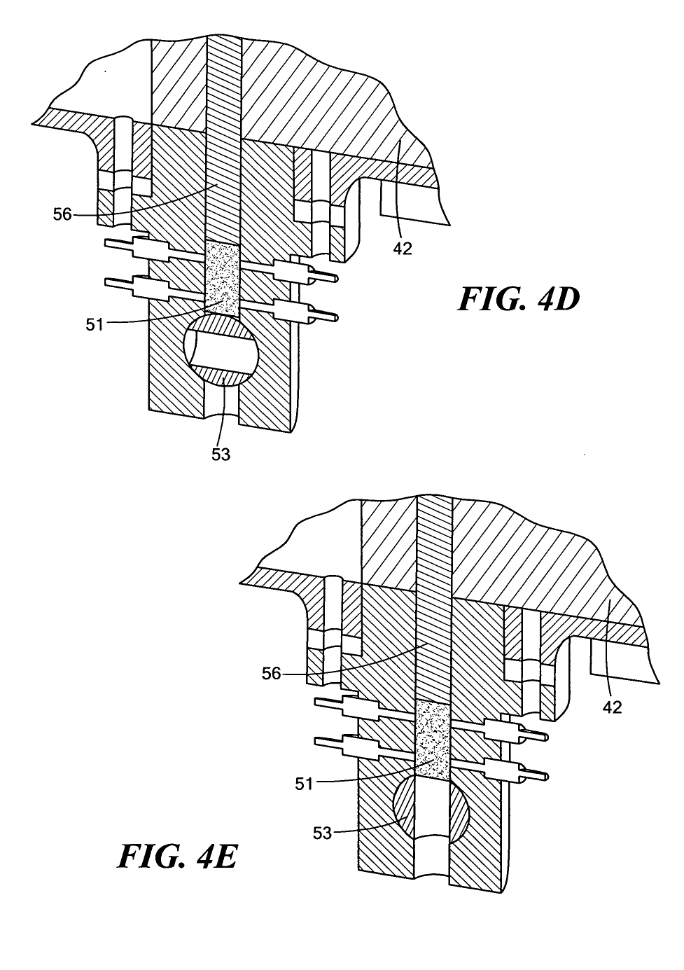

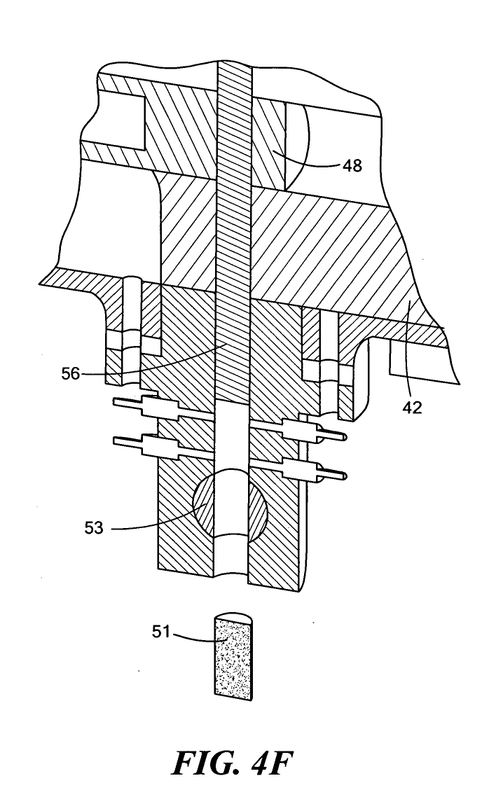

In one example, extractor 30′, FIGS. 3-4 extends through stack wall 40 and includes cylinder 42 with catch funnel 44 within the stack and transverse through hole 46 outside of the stack. Moveable piston 48 within cylinder 42 includes collection volume orifice 50 transversely therethrough in communication with catch funnel 44 when piston 48 is extended into the position shown in FIG. 4A to receive fly-ash in the stack. Excess ash fills funnel 44 and prevents further build-up.

Pellet chamber 52, also outside the stack, is positioned beneath and is in communication with through hole 46 of cylinder 42. Ram 56 is drivable through both cylinder through hole 46 and piston collection volume orifice 50 when piston 48 is retracted to produce a pellet 51 of fly-ash in pellet chamber 52, FIGS. 4B-4C. Typically, the pellet is then transferred via a transfer mechanism configured to transfer the pellet from extractor 30′ to an analyzer. FIGS. 4D-4F show how pellet 51 is allowed to exit pellet chamber 52 via rotation of valve 53 (see valve controller 59, FIG. 4A, operated by controller 34, FIG. 2). Thus, valve 53 serves, in this specific example, as a transfer mechanism for transferring the collected fly-ash from the extractor to the analyzer. Pneumatically driven ram expels pellet 51 as shown in FIGS. 4E-4F.

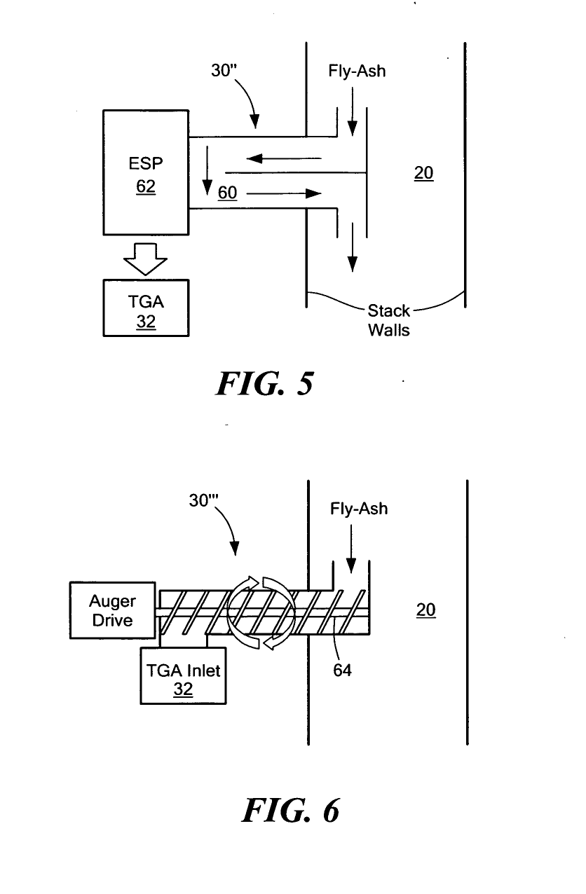

In another embodiment, extractor 30″, FIG. 5 includes an electro-static precipitator. Air duct 60 redirects a small volume of gas/fly-ash exhaust mixture from stack 20 towards electrostatic precipitator 62 which gathers fly-ash on charged plates. These plates are subsequently passed through analyzer 32 for analysis. In another embodiment, extractor 30′″, FIG. 6 includes motor driven rotary auger 64 used to compress and drive the fly-ash into the inlet of analyzer 32. Other extractors are possible, for example cyclone type devices, conveyors, and the like. And, bottom ash rather than fly-ash may be extracted and analyzed.

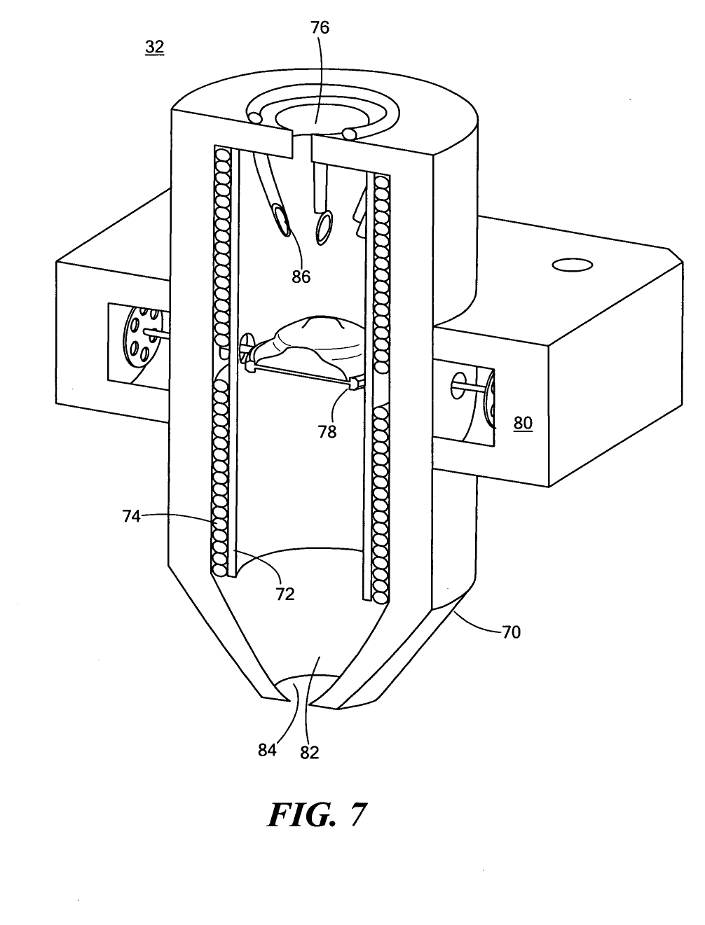

In one example, thermal gravimetric analyzer 32, FIG. 7 is configured to weigh the fly-ash, burn the fly-ash, and then weigh the fly-ash again to determine LOI data. Analyzer 32 includes insulated housing 70 with inner sleeve 72 and heating coils 74. A fly-ash sample, delivered from the extractor via a transfer mechanism, enters port 76 and is then positioned on resonator platform 78 where it is weighed by determining the resonant frequency of the platform/sample combination via electro-magnetic controls/actuator subsystem 80 or by a piezo, micro, or other balance. The temperature of chamber 82 is then increased via heating coils 74 to burn the fly-ash sample. The sample is then weighed again. The difference in weight before and after burning is used by controlling electronics 34, FIG. 2, (typically including an appropriately programmed processor) to determine the LOI data. Thereafter, actuator system 80, FIG. 7 flips resonator platform 78, 90° and the burned fly-ash exits the analyzer via exit port 84. Purge jets 86 are controlled by system 80 to purge any remaining fly-ash from chamber 82 and/or resonator platform 78. The heating chamber may be maintained at a constant temperature (approximately 800° C.) throughout the sampling process. The fly-ash is dropped onto the weighing platform, weighed and quickly combusted. Once the burn is complete, the sample is purged from the chamber via nitrogen gas exiting purged jets 86 and the system is ready for the next sample.

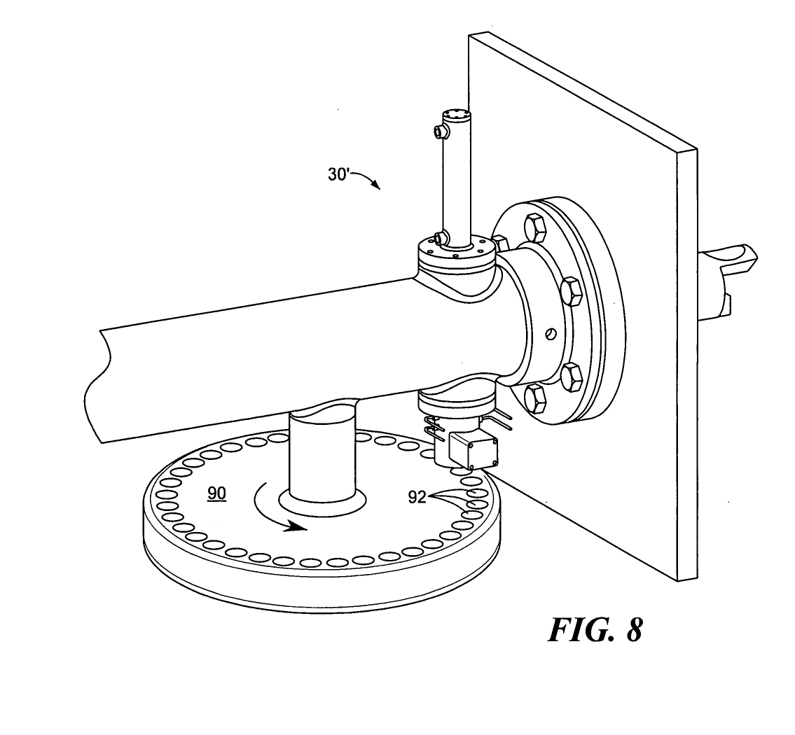

In another embodiment, a thermal gravimetric analyzer available from PerkinElmer, Inc. (Waltham, Mass.) is used, e.g., the STA 6000 Simultaneous Thermal Analyzer with an auto sampler. FIG. 8, for example, shows extractor 30′, FIGS. 3-4, positioned above the input carousel 90 of such an analyzer with fly-ash pellet receptacles 92. Carousel 90 rotates to receive fly-ash pellets (see pellet 51, FIG. 4F) under the control of controller 34, FIG. 2.

The analyzer may be coupled directly to the extractor (and fed fly-ash by gravity, for example, or via an auger or the like) or may receive fly-ash from the extractor via a transfer mechanism. The fly-ash can be in pellet form or in powder form. A pellet of fly-ash may be easier to transfer, but it may also be more difficult to weigh and burn. The powder form of the fly-ash, although easier to burn, may be more difficult to transport and may require other steps taken to clean the extractor, the transfer mechanism, and the analyzer. Other type of analyzers can be used, for example, conductivity and spectrographic analyzers.

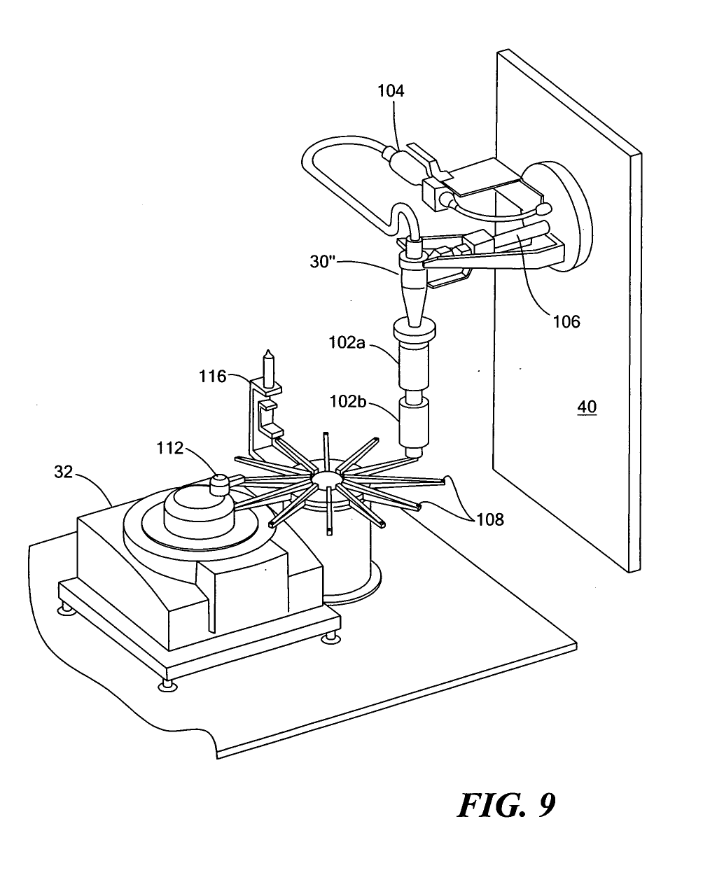

In another version, cyclone extractor 30″, FIG. 9, with dispensing valves 102a and 102b coupled thereto is operated via vacuum generator 104 to both extract ash and purge (clean) the extractor. A conduit 106 through duct wall 40 is used to connect the interior of the duct to cyclone 30″. Dispensing valves 102a and 102b are used to deposit a fly-ash sample in the wells 108 of transfer mechanism 110, in this example, a material handling carousel. Pick and place mechanism 112 of TGA 32 retrieves an ash sample from the wells of handler 110 and presents the ash sample to TGA 32 for analysis. Cleaning station 116 can be used to clean the ash out of wells 108 of handler 110 by a vacuum or purging action. In another example, a TGA is disposed directly below valve 102b which serves as the transfer mechanism.

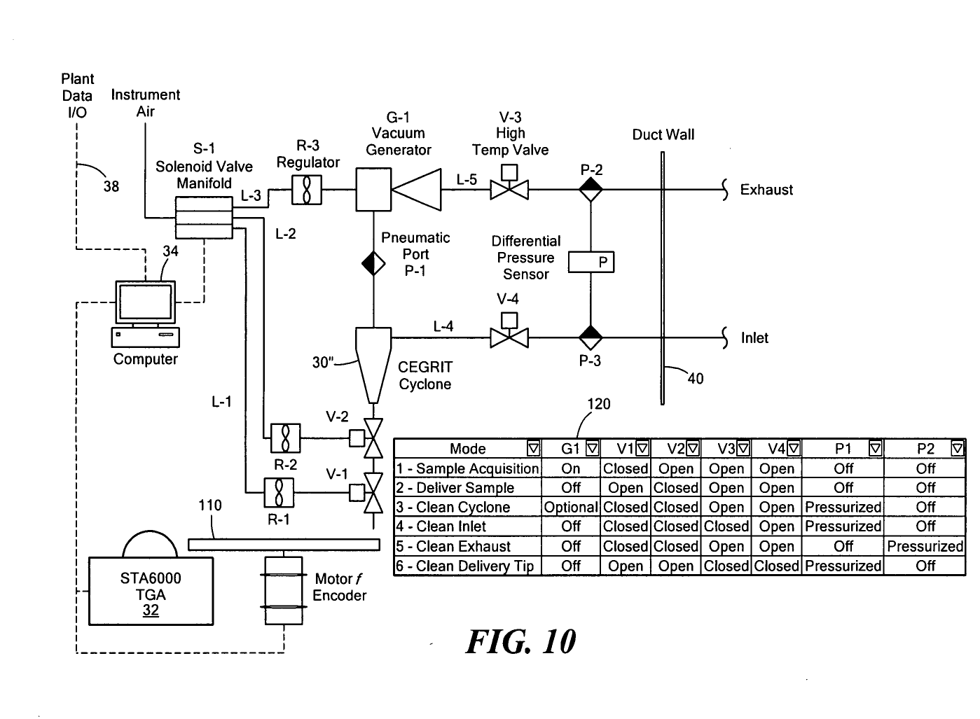

FIG. 10 shows cyclone extractor 30″, handler 110 and TGA 32 along with the valving and control lines used to operate the system. Table 120 delineates the operation of the system during sample acquisition, sample delivery, cleaning, and the like.

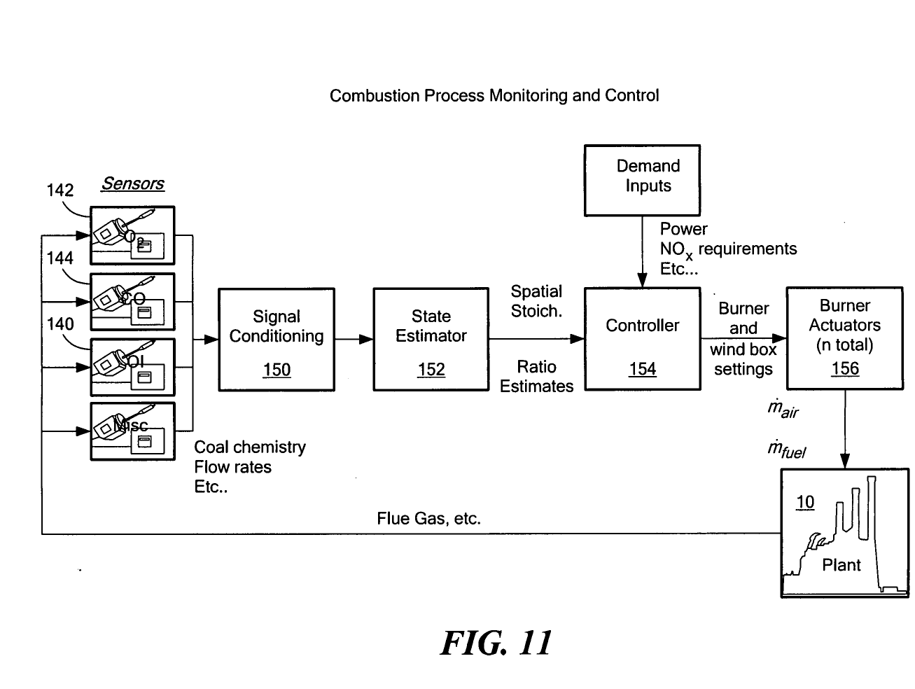

FIG. 11 illustrates how a LOI measurement system 140 can be used with other plant sensors such as oxygen sensor 142, carbon monoxide sensor 144, and the like to control various plant parameters via signal conditioning electronics 150, state estimator 152, and controller 154. In this example, plant burner actuators 156 are controlled by controller 154.

Preferably, the number of moving parts is minimized so that maintenance is not an issue. Also, it is preferred that the complete system is self-cleaning. As noted above, some analyzers employ carousels in which case the transfer mechanism is engineered to provide an interface between the extractor and the carousel of the analyzer.

In other embodiments, coal is analyzed before it is burned in the plant burners. In still other examples, other types of hydrocarbon fuels and/or bi-products of combustion are extracted and analyzed.

The preferred result, in one preferred embodiment, is a system and method for measuring loss-on-ignition directly, on-site, continuously, automatically, and without the need for excessive calibration.

Thus, although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

Other embodiments will occur to those skilled in the art and are within the following claims.

What is claimed is:

1. An in-line loss-on-ignition measurement system comprising:
an extractor configured to collect fuel or a combustion by-product from a hydrocarbon fuel burning plant;
an on-site analyzer configured to receive the collected matter and determine loss-on-ignition data for the plant;
a transfer mechanism configured to transfer the collected matter from the extractor to the analyzer; and
a controller for displaying the loss-on-ignition data and/or for automatically adjusting one or more parameters associated with the plant.

2. The system of claim 1 in which the plant is a coal burning plant.

3. The system of claim 2 in which the by-product is fly-ash.

4. The system of claim 3 in which the analyzer is a thermal gravimetric analyzer configured to weigh the fly-ash, burn the fly-ash, and weigh the fly-ash again to determine loss-on-ignition data.

5. The system of claim 3 in which one or more parameters include the air-to-fuel ratio.

6. The system of claim 3 in which one or more parameters include an adjustment to a pulverizer to change the size of the coal particles.

7. The method of claim 3 in which the extractor extends into an exhaust stack.

8. The system of claim 7 in which the extractor includes:
a body including a catch funnel within the stack and a transverse through hole outside of the stack,
a moveable piston within the body including a collection volume orifice transversely therethrough in communication with the catch funnel when the piston is in an extended position to receive the fly-ash and in communication with the transverse through hole when the piston is retracted;
a pellet chamber outside the stack beneath the body in communication with the transverse through hole, and
a ram drivable through both the body through hole and the piston collection volume orifice when the piston is in the retracted position to produce a pellet of the fly-ash in the pellet chamber.

9. The system of claim 8 in which the transfer mechanism includes a rotatable valve below the pellet chamber for transferring the pellet from the pellet chamber to the analyzer.

10. The system of claim 9 in which the analyzer includes a thermal gravimetric analyzer including a carousel configured to receive fly-ash pellets from the rotatable valve.

11. The method of claim 7 in which the extractor includes an electro-static precipitator.

12. The system of claim 7 in which the extractor includes a motor driven rotary auger.

13. The system of claim 7 in which the extractor is a cyclone device.

14. The system of claim 1 in which the transfer mechanism includes one or more valves.

15. An in-line loss-on-ignition measurement system comprising:
a cyclone extractor configured to collect fuel or a combustion by-product from a hydrocarbon fuel burning plant;
an on-site analyzer configured to receive the collected matter and determine loss-on-ignition data for the plant by weighing the collected matter, burning the collected matter, and weighing the burned collected matter;
a transfer mechanism including one or more valves configured to transfer the collected matter from the extractor to the analyzer; and
a controller for displaying the loss-on-ignition data and/or for automatically adjusting one or more parameters associated with the plant.

16. An in-line loss-on-ignition measurement method comprising:
collecting fuel or a combustion by-product from a hydrocarbon fuel burning plant;
transferring the collected matter to an on-site analyzer;
analyzing the collected matter to determine the loss-on-ignition data for the plant; and
displaying the loss-on-ignition data and/or automatically adjusting one or more plant parameters based on the loss-on-ignition data.

17. The method of claim 16 in which the plant is a coal burning plant.

18. The method of claim 17 in which the by-product is fly-ash.

19. The method of claim 18 in which analyzing includes weighing the fly-ash, burning the fly-ash, and weighing the fly-ash again to determine loss-on-ignition data.

20. The method of claim 17 in which one or more parameters include the air-to-fuel ratio.

21. The method of claim 17 in which one or more parameters include an adjustment to a pulverizer to change the size of the coal particles.

22. The method of claim 16 in which collecting includes:
deploying a catch funnel within the stack to collect fly-ash and compressing the fly-ash into a pellet.

23. The method of claim 22 in which collecting further includes moving the fly-ash outside of the stack before compressing the fly-ash.

24. The method of claim 16 in which collecting includes employing an electro-static precipitator.

25. The method of claim 16 in which collecting includes employing an auger.

26. The method of claim 16 in which collecting includes employing a cyclone device.

27. The method of claim 16 in which analyzing includes employing a gravimetric analyzer.

28. The method of claim 16 in which transmitting includes employing one or more valves.

29. An in-line loss-on-ignition measurement method comprising:
collecting fuel or a combustion by-product from a hydrocarbon fuel burning plant using a cyclone extractor;
transferring the collected matter to an on-site analyzer;
analyzing the collected matter to determine the loss-on-ignition data for the plant by weighing the collected matter, burning the collected matter, and weighing the burned collected matter; and
displaying the loss-on-ignition data and/or automatically adjusting one or more plant parameters based on the loss-on-ignition data.
